(19) United States
(12) Patent Application Publication
(10) Pub. No.: US 2025/0341690 A1
(43) Pub. Date: Nov. 6, 2025

(54) OPTICAL MODULE

(71) Applicant: InnoLight Technology (Suzhou) Ltd., Suzhou , Jiangsu (CN)

(72) Inventors: FANBO MENG, Suzhou , Jiangsu (CN); BOJIE WANG, Suzhou , Jiangsu (CN); SHAMEI SHI, Suzhou , Jiangsu (CN)

(21) Appl. No.: 18/857,464

(22) PCT Filed: Feb. 8, 2023
(86) PCT No.: PCT/CN2023/074913

§ 371 Date: Oct. 17, 2024

(30) Foreign Application Priority Data
Apr. 19, 2022 (CN) 202220909501.1

(51) Int. Cl. G02B 6/42

(52) U.S. Cl. CPC G02B 6/4269

(57) ABSTRACT

An optical module, comprising a housing assembly (10) and a circuit assembly (20), wherein the circuit assembly (20) is arranged inside the housing assembly (10); and the circuit assembly (20) has a first side (M) and a second side (N), which are arranged opposite each other. The optical module further comprises a potting body (30), wherein the potting body (30) is arranged on the circuit assembly (20), and cooperates with the circuit assembly (20) to create a sealed cavity (31), which is located on the first side (M). The optical module further comprises a light emitting/receiving element, a lens (42) and a light guide component (43), wherein a light beam propagation path (P), which is cooperatively formed by the light-emitting/receiving element, the lens (42) and the light guide component (43), is located in the sealed cavity (31); and the second side (N) is in communication with the outside of the housing assembly (10), such that a cooling medium that has entered the housing assembly (10) can come into contact with the circuit assembly (20) to dissipate heat.

### CROSS-REFERENCE TO RELATED PATENT APPLICATION

The present disclosure claims priority to the Chinese patent application filed with the China Patent Office on Apr. 19, 2022, with the application number 202220909501.1 and the invention title “Optical Module”, the entire content of which is incorporated into the present disclosure by reference.

### FIELD OF THE DISCLOSURE

The present disclosure relates to the technical field of optical communication devices, and specifically relates to an optical module.

### BACKGROUND OF THE DISCLOSURE

In recent years, the development of emerging technologies such as data centers, high-performance computing, and 5G communications has placed higher demands on information transmission rates. As a result, the market has increasingly stringent requirements for the speed of optical transceiver modules (hereinafter referred to as optical modules), which are critical components in communication systems. This has led to a significant increase in the power consumption of optical modules. At the same time, the national “dual carbon” strategy and the international pursuit of energy conservation and carbon reduction have made it imperative to reduce the energy consumption of data centers. According to statistics on China's data center energy consumption in 2019, approximately 43% of the energy consumption in traditional data centers using air-cooling technology is devoted to cooling, almost equal to the energy consumption of the equipment itself. Therefore, improving cooling efficiency to reduce related energy consumption and control the operational costs of data centers has become a necessity. As the most representative advanced cooling solution, immersion liquid cooling has recently become a focal point of attention in the relevant industries. To adapt to this trend, the market is urgently demanding the development of optical modules suitable for immersion liquid cooling.

On the other hand, aside from the aforementioned reasons related to national policies and data center energy consumption control, the thermal design of optical modules themselves is currently facing certain bottlenecks. The compact structure of optical modules greatly limits the design space for traditional cooling solutions, which typically involve conducting heat through solids to the exterior and external heat sinks, and then dissipating the heat through forced air cooling. Currently, common cooling design solutions often employ TEC (Thermoelectric Coolers), heat pipes, vapor chambers, or advanced thermal conductive materials such as graphene or liquid metal, or they aim to maximize the thermal conductivity of interface materials. However, these solutions often lead to increased costs, excessive power consumption, and challenges in manufacturing processes. Moreover, based on existing theoretical analyses and experimental data, the effectiveness of these methods may be limited. As module speeds and power consumption increase significantly, the bottlenecks in thermal design are becoming more apparent. The potential solutions, immersion liquid cooling stands out with a cooling efficiency far superior to traditional air-cooling technologies, showing great promise in addressing this future challenge.

However, conventional optical modules currently suffer from low cooling efficiency, and when applying immersion liquid cooling solutions, the cooling liquid can easily penetrate the optical path of the module. This penetration can lead to issues such as abnormal reflection, refraction, and scattering, and may even result in the failure of the optical module.

### SUMMARY OF THE DISCLOSURE

### Technical Problem

The present disclosure provides an optical module that can be adapted to the immersion liquid cooling solution, can reduce the risk of the cooling medium causing adverse effects on the beam propagation path, and has good heat dissipation efficiency and heat dissipation effect.

### Technical Solutions

The present disclosure provides an optical module. The optical module includes a housing assembly. The optical module also includes a circuit assembly arranged inside the housing assembly, wherein the circuit assembly has a first side and a second side that are arranged opposite each other. The optical module also includes a potting body arranged on the circuit assembly and cooperating with the circuit assembly to create a sealed cavity located on the first side. The optical module also includes a light emitting/receiving element, a lens and a light guide component, wherein a light beam propagation path cooperatively formed by the light-emitting/receiving element, the lens and the light guide component is located in the sealed cavity; wherein the second side is in communication with an outside of the housing assembly, such that a cooling medium that has entered the housing assembly comes into contact with the circuit assembly to dissipate heat.

In one embodiment of the present disclosure, a potting cavity and a first heat dissipation cavity are formed between the circuit assembly and the housing assembly; the potting cavity is located on the first side, and the potting body is potted in the potting cavity; the first heat dissipation cavity is located on the second side, and the first heat dissipation cavity is in communication with an outside of the housing assembly, such that the cooling medium entering the housing assembly comes into contact with a surface of the circuit assembly facing toward the first cooling cavity.

In one embodiment of the present disclosure, a second heat dissipation cavity is formed between the circuit assembly and the housing assembly; the second heat dissipation cavity is located on the first side, and the second heat dissipation cavity and the potting cavity are spaced apart from each other; wherein, the second heat dissipation cavity is in communication with an outside of the housing assembly, such that the cooling medium entering the housing assembly comes into contact with the surface of the circuit assembly facing the second heat dissipation cavity.

In one embodiment of the present disclosure, the housing assembly is provided with a first retaining wall and a second retaining wall on the first side; the second heat dissipation cavity is defined by the housing assembly, the circuit assembly, the first retaining wall and the second retaining wall, and the potting cavity is located on one side of the first retaining wall facing away from the second retaining wall.

In one embodiment of the present disclosure, the light guide component includes an optical fiber and an optical fiber fixing member located at an end of the optical fiber; wherein, the light emitting/receiving element, the lens and the optical fiber fixing member are all located in the sealed cavity.

In one embodiment of the present disclosure, the circuit assembly includes a circuit board and an electronic device; a surface of the circuit board facing the first side and/or the second side is provided with the electronic device, the electronic device is not covered by the potting body, and the electronic device directly contacts the cooling medium to dissipate heat; and/or a surface of the circuit board facing the first side is provided with the electronic device, the electronic device is covered by the potting body, the circuit board is further provided with a thermal conductive structure extending from the first side to the second side, the electronic device is in communication with the thermal conductive structure on the first side, and heat generated by the electronic device is conducted to the second side through the thermal conductive structure for heat dissipation.

In one embodiment of the present disclosure, the optical module further includes a first limiting body and a second limiting body, and the first limiting body, the second limiting body, the circuit assembly and the housing assembly cooperate to form the potting cavity; the first limiting body is sandwiched between the circuit assembly and the housing assembly and forms a seal; the second limiting body is provided on the housing assembly and is spaced apart from the circuit assembly, a potting opening is formed between the second limiting body and the circuit assembly, and the potting body is potted in the potting cavity through the potting opening, wherein the potting body at a position of the potting opening is submerged beyond an edge of the circuit assembly facing the first side.

In one embodiment of the present disclosure, the optical module further includes: a potting mold provided on the circuit assembly and cooperating with the circuit assembly to form a potting cavity, wherein the potting body is potted in the potting cavity.

In one embodiment of the present disclosure, the optical module further includes an isolation component; the isolation component is disposed in the sealed cavity, and the light beam propagation path is isolated from the potting body through the isolation component.

In one embodiment of the present disclosure, the circuit assembly includes a circuit board, and the light emitting/receiving element is provided on the circuit board; the isolation component includes an isolation cover and an isolation body; the lens covers the light emitting/receiving element, and the isolation cover is provided on a side of the lens facing away from the light emitting/receiving element; wherein, the isolation body forms a seal between the lens and the circuit board, between the lens and the isolation cover, between the lens and the light guide component, between the light guide component and the isolation cover, and between the light guide component and the circuit board.

In one embodiment of the present disclosure, the circuit assembly includes a circuit board, and the light emitting/receiving element is provided on the circuit board; the isolation component includes a total reflection element and an isolation body; the lens covers the light emitting/receiving element, a surface of the lens facing away from the light emitting/receiving element has a reflection area, and the light beam is totally reflected in the reflection area; wherein, the total reflection element is attached to the reflection area, and the isolation body forms a seal between the lens and the circuit board, between the lens and the light guide component, and between the light guide component and the circuit board.

### Beneficial Effects

The beneficial effects of the present disclosure are that: different from the existing technology, the present disclosure provides an optical module. The potting body and the circuit assembly in the optical module cooperate to form a sealed cavity. The light beam propagation path formed by the cooperation of the light emitting/receiving element, and the lens and the light guide component is in a sealed cavity. In other words, the optical module of the present disclosure can be adapted to the immersed liquid cooling solution. The beam propagation path is isolated from the cooling medium through the potting body. The cooling medium will not penetrate into the beam propagation path, thus reducing the risk of the cooling medium adversely affecting the beam propagation path.

Moreover, the second side of the circuit assembly is in communication with the outside of the housing assembly, such that the cooling medium entering the housing assembly can come into contact with the circuit assembly for heat dissipation, meaning that the optical module of the present disclosure has good heat dissipation efficiency and heat dissipation effect.

### BRIEF DESCRIPTION OF THE DRAWINGS

In order to more clearly illustrate the technical solutions in the embodiments of the present disclosure, the drawings needed to be used in the description of the embodiments will be briefly introduced below. Obviously, the drawings in the following description are only some embodiments of the present disclosure. For those skilled in the art, other drawings can also be obtained based on these drawings without exerting creative efforts.

FIG. 1 is a schematic structural diagram of the first embodiment of the optical module of the present disclosure;

FIG. 2 is a schematic diagram of an embodiment of a cross-sectional structure of the optical module in the K-K direction shown in FIG. 1;

FIG. 3 is a schematic structural diagram of area A of the optical module shown in FIG. 2;

FIG. 4 is a schematic structural diagram of area B of the optical module shown in FIG. 3;

FIG. 5 is a schematic structural diagram of area C of the optical module shown in FIG. 2;

FIG. 6 is a schematic structural diagram of area D of the optical module shown in FIG. 2;

FIG. 7 is a schematic cross-sectional structural diagram of the second embodiment of the optical module of the present disclosure;

FIG. 8 is a schematic cross-sectional structural diagram of the third embodiment of the optical module of the present disclosure;

FIG. 9 is a schematic cross-sectional structural diagram of the fourth embodiment of the optical module of the present disclosure;

FIG. 10 is a schematic structural diagram of area E of the optical module shown in FIG. 9;

FIG. 11 is a schematic diagram of another embodiment of a cross-sectional structure of the optical module in the K-K direction shown in FIG. 1;

FIG. 12 is a schematic structural diagram of area F of the optical module shown in FIG. 11;

FIG. 13 is a schematic structural diagram of an embodiment of the assembly process of the circuit board, the light emitting/receiving component, the lens and the light guide component according to the present disclosure;

FIG. 14 is a schematic structural diagram of an embodiment of the potting process of the potting body of the present disclosure; and

FIG. 15 is a schematic structural diagram of the potting process of the potting body of the present disclosure from another perspective.

### EXPLANATION OF REFERENCE NUMERALS

10 housing assembly, 11 first retaining wall, 12 second retaining wall, 13 upper housing, 14 lower housing, 20 circuit assembly, 21 first heat dissipation cavity, 22 second heat dissipation cavity, 23 circuit board, 24 chip, 30 potting body, 31 sealed cavity, 32 potting cavity, 33 first limiting body, 34 second limiting body, 35 potting opening, 36 potting mold, 41 light emitting element, 42 lens, 421 reflection area, 422 incident area, 423 exit area, 43 light guide component, 431 mounting hole, 432 optical fiber, 433 optical fiber fixing piece, 434 end face, 50 isolation component, 51 isolation cover, 52 isolation body, 53 total reflection element.

### DETAILED DESCRIPTION OF THE EXEMPLARY EMBODIMENTS

The technical solutions in the embodiments of the present disclosure will be clearly and completely described below with reference to the accompanying drawings in the embodiments of the present disclosure. Obviously, the described embodiments are only some of the embodiments of the present disclosure, rather than all of the embodiments. Based on the embodiments in the present disclosure, all other embodiments obtained by those skilled in the art without making creative efforts fall within the scope of protection of the present disclosure. In addition, it should be understood that the specific embodiments described here are only used to illustrate and explain the application, and are not used to limit the application. In the present disclosure, unless otherwise specified, directional words such as “up”, “down”, “left” and “right” generally refer to the up, down, left and right of the device in actual use or working state, specifically the drawing direction in the accompanying drawings.

The present disclosure provides an optical module, which will be described in detail below. It should be noted that the description order of the following embodiments does not limit the preferred order of the embodiments of the present disclosure. In the following embodiments, each embodiment is described with its own emphasis. For parts that are not described in detail in a certain embodiment, please refer to the relevant descriptions of other embodiments.

In order to solve the technical problem in the prior art that coolant easily penetrates into the optical path of an optical module, an embodiment of the present disclosure provides an optical module. The optical module includes a housing assembly. The optical module further includes a circuit assembly. The circuit assembly is disposed in the housing assembly, wherein the circuit assembly has a first side and a second side that are oppositely arranged. The optical module also includes a potting body, which is disposed on the circuit assembly and cooperates with the circuit assembly to form a sealed cavity on the first side. The optical module also includes a light emitting/receiving element, a lens and a light guide component. The light beam propagation path formed by the light emitting/receiving element, the lens and the light guide component is in a sealed cavity. The second side is in communication with the outside of the housing assembly, such that the cooling medium entering the housing assembly can contact the circuit assembly for heat dissipation. This is explained in detail below.

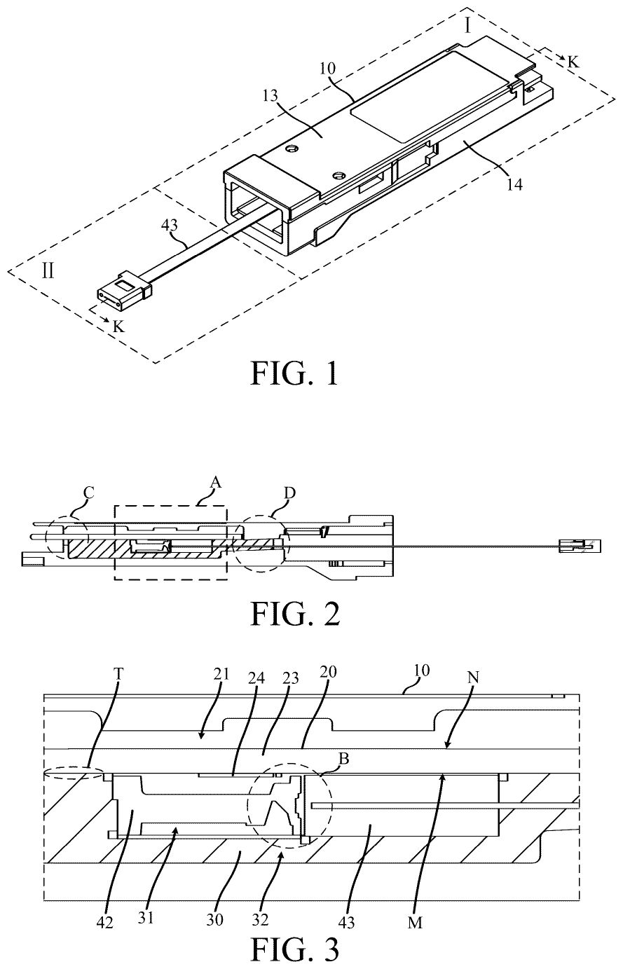

Please refer to FIGS. 1 to 3. FIG. 1 is a schematic structural diagram of the first embodiment of the optical module of the present disclosure. FIG. 2 is a schematic diagram of an embodiment of a cross-sectional structure of the optical module in the K-K direction shown in FIG. 1. FIG. 3 is a schematic structural diagram of area A of the optical module shown in FIG. 2.

In one embodiment, the optical module includes a housing assembly 10. The housing assembly 10 is the basic carrier of the optical module, and at least plays the role of carrying and protecting other components of the optical module.

The optical module also includes a circuit assembly 20. The circuit assembly 20 is disposed in the housing assembly 10. The circuit assembly 20 has a first side M and a second side N arranged oppositely, as shown in FIG. 3.

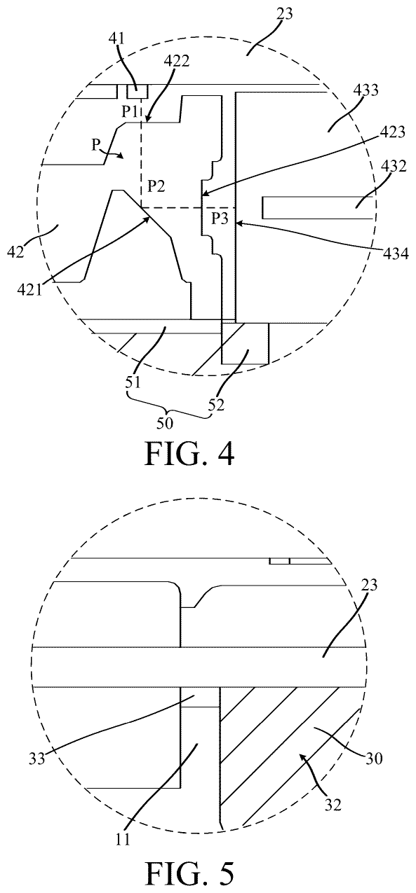

Please also refer to FIG. 4. The optical module also includes a light emitting/receiving element (such as the light emitting element 41 described below), a lens 42 and a light guide component 43. The light emitting/receiving element is provided on the circuit assembly 20. When the light emitting/receiving element is specifically a light emitting element, the light emitting element responds to the electrical signal of the circuit assembly 20 and outputs a corresponding optical signal, and the optical signal is transmitted to the light guide component 43 through the lens 42; and when the light emitting/receiving element is specifically a light receiving element, the optical signal transmitted by the light guide component 43 is transmitted to the light receiving element through the lens 42, and the light receiving element receives the optical signal and converts the optical signal into a corresponding electrical signal. The optical module communicates optical signals with external devices through the light guide component 43.

In the embodiment of the present disclosure, the light emitting/receiving element may be a light emitting element, that is, the optical module only includes a light emitting element, and the optical module is used to output an optical signal to an external device; or the light emitting/receiving element may be a light receiving element, that is, the light module only includes a light-receiving element, and the optical module is used to receive optical signals input from an external device; or the light-emitting/receiving element can include both a light-emitting element and a light-receiving element, that is, the optical module includes both a light-emitting element and a light-receiving element. The optical module can not only output optical signals to external devices, but also receive optical signals input from external devices. The optical module can be provided with groups of light emitting elements and groups of light receiving elements, where the number of light emitting elements in each group can be 4, etc., and the number of light receiving elements in each group can also be 4, etc.

The following description takes the light emitting/receiving element, specifically the light emitting element 41, as an example. This is only for discussion purposes and is not intended to be limiting. Alternatively, the light emitting element 41 may be a laser or the like. The light guide component 43 may include an optical fiber 432 and an optical fiber fixing member 433 provided at the end of the optical fiber 432. The end of the optical fiber 432 is fixed to the circuit assembly 20 through the optical fiber fixing member 433.

The optical module also includes a potting body 30. The potting body 30 is potted on the circuit assembly 20, and the potting body 30 cooperates with the circuit assembly 20 to form a sealed cavity 31 on the first side M, that is, the sealed cavity 31 is defined by the potting body 30 and the circuit assembly 20. Specifically, at least part of the potting body 30 is located on the first side M, and the at least part cooperates with the circuit assembly 20 to form the sealed cavity 31. It can be understood that the potting body 30 may be entirely located on the first side M of the circuit assembly 20. Certainly, the potting body 30 can also be partially located on the first side M, and the remaining portion extends to other sides of the circuit assembly 20 (for example, the second side N). In the following description, it is taken as an example that the potting body 30 is entirely located on the first side M of the circuit assembly 20. This is only for discussion purposes and is not intended to be limiting.

In this embodiment, the light emitting element 41, the lens 42 and the light guide component 43 are cooperated to form a beam propagation path P, and the optical signal transmitted between the light emitting element 41, the lens 42 and the light guide component 43 propagates along the beam propagation path P. Specifically, the beam propagation path P includes a sub-path P1, a sub-path P2 and a sub-path P3. The surface of the lens 42 has an incident area 422, a reflection area 421 and an exit area 423. Other areas on the surface of the lens 42 do not participate in forming the beam propagation path P. The optical signal output by the light emitting element 41 propagates along the sub-path P1 to the lens 42 and is incident into the lens 42 from the incident region 422; the optical signal incident from the incident region 422 propagates along the sub-path P2 in the lens 42 and undergoes a total reflection in the reflection region 421, and then exits from the exit area 423; the optical signal exiting from the exit area 423 propagates along the sub-path P3, and is incident from the light guide component 43 toward the end surface 434 of the lens 42 into the light guide component 43, and then output to an external device through the light guide component 43.

In this embodiment, the light beam propagation path P formed by the cooperation of the light emitting element 41, the lens 42 and the light guide component 43 is located in the sealed cavity 31. In other words, in this embodiment, the sub-path P1 between the light-emitting element 41 and the incident area 422, the sub-path P2 between the incident area 422 and the exit area 423 in the lens 42, and the sub-path P3 between the exit area 423 and the end surface 434 of the light guide component 43 are in the sealed cavity 31.

Through the above method, the optical module of this embodiment can be adapted to the immersion liquid cooling solution. The beam propagation path P is isolated from the cooling medium (such as cooling liquid) through the potting body 30, and the cooling medium will not penetrate into the beam propagation path P, thus reducing the risk of the cooling medium causing adverse effects on the beam propagation path P. This means that the beam propagation path P in this embodiment is reliably sealed by the potting body 30, and the optical module can operate stably for a long time while being immersed in the cooling medium.

Furthermore, the second side N of the circuit assembly 20 in this embodiment is in communication with the outside of the housing assembly 10, so that the cooling medium entering the housing assembly 10 can contact the circuit assembly 20 for heat dissipation. This means that the optical module of this embodiment can use an immersed liquid cooling solution. The immersed liquid cooling solution has good heat dissipation efficiency and heat dissipation effect, which is conducive to ensuring that the optical module of this embodiment has good heat dissipation efficiency and heat dissipation effect.

It should be noted that in the embodiment of the present disclosure, at least the beam propagation path P formed by the light emitting element 41, the lens 42 and the light guide component 43 is in the sealed cavity 31, which can prevent the cooling medium and the potting body 30 from affecting the beam propagation path P to cause adverse effects. In the embodiment of the present disclosure, it is preferred that the light emitting element 41, the entire lens 42, and the optical fiber fixing member 433 are all located in the sealed cavity 31, thereby minimizing the adverse effects of the cooling medium and the potting body 30 on the beam propagation path P.

Certainly, in other embodiments of the present disclosure, other areas of the lens 42 except the incident area 422, the reflection area 421 and the exit area 423 are allowed to be outside the sealed cavity 31, and it is also allowed that the other parts of the light guide component 43 except the end surface 434 are outside the sealed cavity 31, and the present disclosure is not limited here.

In one embodiment, the potting cavity 32 and a first heat dissipation cavity 21 are formed between the circuit assembly 20 and the housing assembly 10. In other words, the housing assembly 10 has an accommodating space inside, the circuit assembly 20 is disposed in the accommodating space, and the accommodating space is divided into the potting cavity 32 and the first heat dissipation cavity 21. The potting cavity 32 is defined by the housing assembly 10 and the circuit assembly 20 (to be explained in detail below), and the potting cavity 32 covers the sealed cavity 31; the first heat dissipation cavity 21 is defined by the housing assembly 10 and the circuit assembly 20.

The potting cavity 32 is located on the first side M, and the potting body 30 is potted in the potting cavity 32. The potting process of the potting body 30 will be explained below. The first heat dissipation cavity 21 is located on the second side N, and the first heat dissipation cavity 21 is in communication with the outside of the housing assembly 10, so that the cooling medium entering the housing assembly 10 can contact the surface of the circuit assembly 20 facing the first heat dissipation cavity 21 for efficient heat dissipation.

Through the above method, this embodiment rationally plans the accommodating space inside the housing assembly 10, so that the potting body 30 forms the sealed cavity 31 on the first side M of the circuit assembly 20 to control the optical path of the optical module (i.e., the beam propagation path P) for reliable sealing; and, the second side N of the circuit assembly 20 forms the first heat dissipation cavity 21 to adapt to the immersion liquid cooling solution, and the cooling medium entering the housing assembly 10 can contact the circuit assembly 20 in the first heat dissipation cavity 21 for efficient heat dissipation. In other words, the optical module of this embodiment not only has good heat dissipation efficiency and heat dissipation effect, but also can prevent the cooling medium from penetrating into the beam propagation path P and causing adverse effects on the beam propagation path P as much as possible.

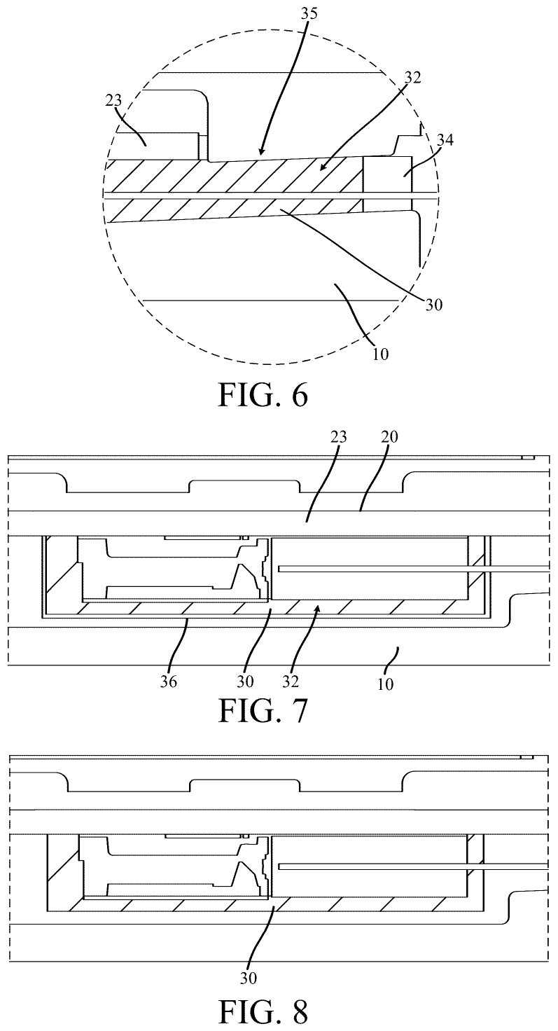

Please refer to FIGS. 5 and 6 together. FIG. 5 is a schematic structural diagram of area C of the optical module shown in FIG. 2 and FIG. 6 is a schematic structural diagram of area D of the optical module shown in FIG. 2.

In one embodiment, the potting process of the potting body 30 may be to fill the potting cavity 32 with uncured potting material. After the potting material is solidified, the potting body 30 is formed in the potting cavity 32. The optical module also includes a first limiting body 33 and a second limiting body 34. The first limiting body 33, the second limiting body 34, the circuit assembly 20 and the housing assembly 10 are cooperated to form the potting cavity 32.

Specifically, the first limiting body 33 is sandwiched between the circuit assembly 20 and the housing assembly 10 to form a seal to prevent uncured potting material from leaking through the gap between the circuit assembly 20 and the housing assembly 10 at the location of the first limiting body 33. Furthermore, the second limiting body 34 is provided on the housing assembly 10 and is spaced apart from the circuit assembly 20, so that a potting opening 35 is formed between the second limiting body 34 and the circuit assembly 20. The potting body 30 is potted in the potting cavity 32 through the potting port 35, that is, the uncured potting material is poured into the potting cavity 32 through the potting port 35, and then solidifies to form the potting body 30.

In this embodiment, the potting body 30 is potted in the potting cavity 32 through the above method. The potting body 30 has good sealing reliability, and the potting method of this embodiment can be applied to the mass production process of optical modules, which not only has a high potting efficiency but also can ensure a high yield. Traditional optical modules rely on dispensing glue to seal the gap to achieve sealing, which is difficult to operate, has poor mass production, and the sealing reliability is not high. The potting method of this embodiment can completely seal the space near the beam propagation path P after the potting material solidifies to form the potting body 30, which is simple to operate, has strong mass production, and the sealing effect is extremely reliable.

Alternatively, the first limiting body 33 and the second limiting body 34 may be solidified colloid or electromagnetic shielding material. When the first limiting body 33 and the second limiting body 34 are made of electromagnetic shielding materials, the electromagnetic compatibility of the optical module can be improved.

Further, the potting body 30 at the location of the potting opening 35 is submerged beyond the edge of the circuit assembly 20 toward the first side M, as shown in FIG. 6. The circuit assembly 20 includes a circuit board 23. The first limiting body 33, the second limiting body 34, the circuit board 23 and the housing assembly 10 are cooperated to form a potting cavity 32. During the potting process, in order to ensure that the potting material fills the potting cavity 32, when the potting material is poured through the potting opening 35, it is necessary to ensure that the potting material is submerged beyond the edge of the circuit board 23 facing the first side M. After the potting material is solidified, the potting body 30 at the position of the potting opening 35 has submerged the edge of the circuit board 23 facing the first side M.

For example, the housing assembly 10 is provided with a first retaining wall 11 on the first side M. The first limiting body 33 is sandwiched between the circuit assembly 20 and the first retaining wall 11 and forms a seal to prevent the uncured potting material from leaking through the gap between the circuit assembly 20 and the first retaining wall 11 where the first limiting body 33 is located, as shown in FIG. 5.

Optionally, the potting material can be various types of potting glue, such as epoxy resin, silicone resin, acrylic resin, etc., or low-pressure injection molding materials. The uncured potting material has a fluid form. After being injected and filled into the potting cavity 32, it is solidified by standing or other special process means.

It should be noted that in this embodiment, the circuit assembly 20 and the housing assembly 10 are used to cooperate to form the potting cavity 32, that is, the circuit assembly 20 and the housing assembly 10 are used to cooperate to form the container of the potting body 30. Specifically, the housing assembly 10, the first retaining wall 11, the first limiting body 33, the second limiting body 34, and the circuit assembly 20 thereon define the potting cavity 32.

Please also refer to FIG. 7. Certainly, in other embodiments of the present disclosure, the potting cavity 32 may also be formed without the use of the housing assembly 10. Specifically, the optical module also includes a potting mold 36. The potting mold 36 is provided on the circuit assembly 20, the potting mold 36 cooperates with the circuit assembly 20 to form the potting cavity 32 (specifically, the potting mold 36 cooperates with the circuit board 23 to form the potting cavity 32), and the potting body 30 is potted in the potting cavity 32. Moreover, the potting mold 36 can be retained in the optical module, or the potting mold 36 can be disassembled after curing to form the potting body 30, as shown in FIG. 8, which is not limited here.

Please continue to see FIGS. 3 and 4. In one embodiment, considering that the uncured potting material has certain fluidity, if the uncured potting material penetrates into the beam propagation path P of the optical module, it will also have a negative impact on the beam propagation path P.

In view of this, the optical module of this embodiment also includes an isolation component 50. The isolation component 50 is disposed in the sealed cavity 31, and the beam propagation path P is isolated from the potting body 30 through the isolation component 50, so as to avoid the potting body 30 penetrating into the beam propagation path P before curing and causing adverse effects on the light beam propagation path P as much as possible. It can be understood that in this embodiment, before the potting body 30 is formed by potting, the isolation component 50 is pre-arranged to block the uncured potting material and prevent the uncured potting material from penetrating into the light beam propagation path P of the optical module.

In an exemplary embodiment, as shown in FIG. 4, the surface of the lens 42 facing away from the light emitting element 41 has a reflection area 421, and the light beam transmitted between the light emitting element 41 and the light guide component 43 undergoes a total reflection in the reflection area 421. If the potting body 30 contacts the reflection area 421, the reflection of the light beam in the reflection area 421 will be adversely affected.

In view of this, the isolation assembly 50 of this embodiment includes an isolation cover 51. The lens 42 covers the light emitting element 41, and the isolation cover 51 is provided on the side of the lens 42 facing away from the light emitting element 41. The lens 42 is isolated from the potting body 30 by the isolation cover 51, so that the reflection area 421 is isolated from the potting body 30 by the isolation cover 51. The isolation cover 51 not only isolates the reflection area 421 from the potting body 30, but also isolates other areas of the surface of the lens 42 away from the light emitting element 41 from the potting body 30 through the isolation cover 51, thereby minimizing the risk of the potting body 30 affecting the light beam propagation path P.

The isolation assembly 50 also includes an isolation body 52. The assembly gaps between the circuit board 23, the lens 42, the light guide component 43 and the isolation cover 51 are all sealed by the isolation body 52, so that the light beam propagation path P is isolated from the potting body 30 through the isolation assembly 50. Specifically, the isolation body 52 forms a seal between the lens 42 and the circuit board 23, between the lens 42 and the isolation cover 51, between the lens 42 and the light guide component 43, between the light guide component 43 and the isolation cover 51, and between the light guide component 43 and the circuit board 23.

Optionally, in this embodiment, the isolation cover 51 is in a sheet-like structure. Certainly, in other embodiments of the present disclosure, the isolation cover 51 can also be in the form of a film structure, a glue structure, etc., and can function as an isolation lens 42 and the potting body 30. Moreover, the isolation body 52 can be formed by dispensing glue, that is, the isolation body 52 is a solidified colloid. Certainly, in other embodiments of the present disclosure, the isolation body 52 can also be formed by welding methods such as soldering, laser welding, etc., that is, the isolation body 52 is a welded body; the isolation body 52 can also be formed by sealing strips, that is, the isolation body 52 is a sealing strip.

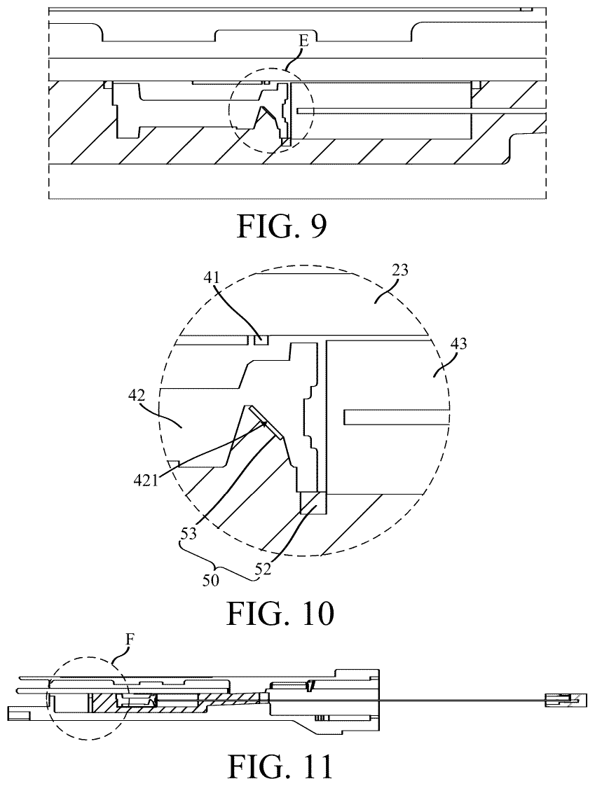

Please refer to FIGS. 9 and 10 together. FIG. 9 is a schematic cross-sectional structural diagram of the fourth embodiment of the optical module of the present disclosure and FIG. 10 is a schematic structural diagram of area E of the optical module shown in FIG. 9.

In another exemplary embodiment, the difference between this embodiment and the above-mentioned embodiment is that the above-mentioned reflection area 421 is no longer isolated from the potting body 30 by the isolation cover 51. The isolation component 50 includes a total reflection element 53. The total reflection element 53 is attached to the reflection area 421, that is, the reflection area 421 is isolated from the potting body 30 through the total reflection element 53. The total reflection element 53 can ensure that the light beam is totally reflected in the reflection area 421. The other areas of the surface of the lens 42 that are away from the light emitting element 41 are not attached with the total reflection element 53.

The isolation assembly 50 also includes the isolation body 52. The assembly gaps between the circuit board 23, the lens 42 and the light guide component 43 are all sealed by the isolation body 52, so that the light beam propagation path P is isolated from the potting body 30 through the isolation assembly 50. Specifically, the isolation body 52 forms a seal between the lens 42 and the circuit board 23, between the lens 42 and the light guide component 43, and between the light guide component 43 and the circuit board 23.

Optionally, the total reflection element 53 may be a total reflection film or a total reflection patch, or the like. In this embodiment, by coating the reflection area 421 with a total reflection film or attaching a total reflection patch, the reflection area 421 is isolated from the potting body 30 through the total reflection element 53.

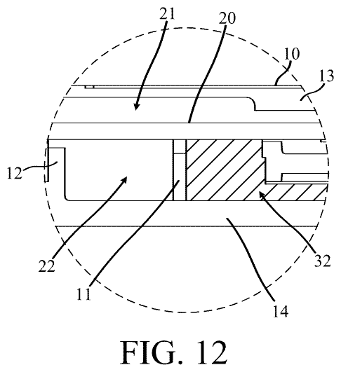

Please refer to FIGS. 11 and 12 together. FIG. 11 is a schematic diagram of another embodiment of a cross-sectional structure of the optical module in the K-K direction shown in FIG. 1 and FIG. 12 is a schematic structural diagram of area F of the optical module shown in FIG. 11.

In one embodiment, a second heat dissipation cavity 22 is also formed between the circuit assembly 20 and the housing component 10, that is, the circuit assembly 20 cooperates with the housing component 10 to divide the accommodating space into the second heat dissipation cavity 22. The second heat dissipation cavity 22 is located on the first side M of the circuit assembly 20, and the second heat dissipation cavity 22 and the potting cavity 32 are spaced apart from each other. The second heat dissipation cavity 22 is in communication with the outside of the housing assembly 10, so that the cooling medium entering the housing assembly 10 can contact the surface of the circuit assembly 20 facing the second heat dissipation cavity 22 for efficient heat dissipation.

In other words, in this embodiment, not only the surface of the circuit assembly 20 facing the second side N is used to contact the cooling medium for efficient heat dissipation, but at least part of the surface of the circuit assembly 20 facing the first side M is also used to contact the cooling medium for efficient heat dissipation. In this embodiment, when the potting body 30 is sufficient to reliably seal the beam propagation path P, the surface area of the circuit assembly 20 for contacting the cooling medium is increased, which further helps to improve the heat dissipation efficiency and effect.

Specifically, the housing assembly 10 is provided with the first retaining wall 11 and the second retaining wall 12 on the first side M. The first retaining wall 11 and the second retaining wall 12 are spaced apart from each other. The potting cavity 32 is located on the side of the first retaining wall 11 away from the second retaining wall 12, and the second heat dissipation cavity 22 is located between the first retaining wall 11 and the second retaining wall 12. The second heat dissipation cavity 22 is defined by the housing assembly 10, the circuit assembly 20, the first retaining wall 11 and the second retaining wall 12.

The housing assembly 10 may include an upper housing 13 and a lower housing 14. The upper housing 13 and the lower housing 14 are butted together to form the accommodating space. The circuit assembly 20 cooperates with the upper housing 13 to form the first heat dissipation cavity 21, and the circuit assembly 20 cooperates with the lower housing 14 to form the potting cavity 32 and the second heat dissipation cavity 22. The first retaining wall 11 and the second retaining wall 12 are specifically provided on the lower housing 14.

In one embodiment, when the optical module uses an immersion liquid cooling solution, an area I of the optical module is immersed in the cooling medium. The cooling medium will fill the internal space of the optical module in the area I. Therefore, when designing the optical module, the user can consider arranging high-power electronic devices in the area I. These electronic devices can directly or indirectly contact the cooling medium, which can achieve good heat dissipation effect. An area II is exposed from the cooling medium and interfaces with other external devices of the communication system to interact with information and data, as shown in FIG. 1.

The circuit assembly 20 includes a circuit board 23 and an electronic device, where the electronic device may include a chip 24 and the like. The surface of the circuit board 23 facing the first side M and/or the second side N is provided with an electronic device, and the electronic device is not covered by the potting body 30, and the electronic device can directly contact the cooling medium for heat dissipation.

Taking the first heat dissipation cavity 21 and the second heat dissipation cavity 22 as an example, the electronic device in the first heat dissipation cavity 21 faces the second side N and is not covered by the potting body 30. This part of the electronic device can directly contact and enter the first heat dissipation cavity. The cooling medium in the heat dissipation cavity 21 dissipates heat. The electronic device in the second heat dissipation cavity 22 faces the first side M and is not covered by the potting body 30. The electronic device can directly contact the cooling medium entering the second heat dissipation cavity 22 for heat dissipation.

In an alternative embodiment, the surface of the circuit board 23 facing the first side M is provided with an electronic component, and the electronic component is covered by the potting body 30. The electronic device covered by the potting body 30 may include the electronic device that is in direct contact with the potting body 30, such as the electronic device in area T in FIG. 3. The electronic device covered by the potting body 30 may also include an electronic device that is not in direct contact with the potting body 30, such as the electronic device in the sealed cavity 31 (i.e., the chip 24, the light emitting element 41, etc.). The circuit board 23 is also provided with a thermal conductive structure (not shown) extending from the first side M to the second side N. The electronic device covered by the potting body 30 is in communication with the thermal conductive structure on the first side M. The heat generated by this part of the electronic device can be conducted to the second side N through the thermal conductive structure for heat dissipation, which is beneficial to improving the heat dissipation efficiency and heat dissipation effect of the optical module.

Optionally, the thermal conductive structure may include thermal conductive holes and/or thermal conductive holes and thermal conductors embedded therein, etc. The thermal holes can be made on the circuit board 23 by laser or other means, and the thermal conductor can be made of materials with good thermal conductivity such as copper.

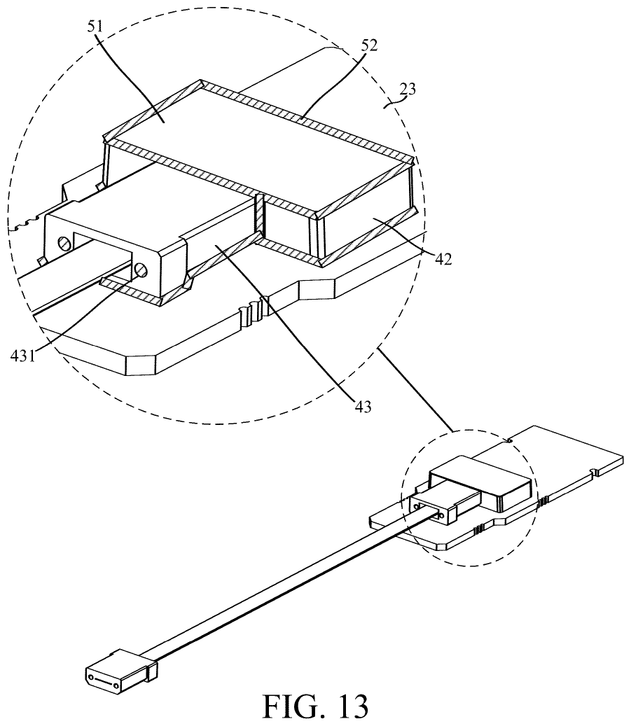

Please refer to FIG. 13 to FIG. 15 together. The following is a general description of the assembly process of the optical module according to the embodiment of the present disclosure.

S101: assembling the light emitting component, the lenses and the light guide component on the circuit board.

In this embodiment, as shown in FIG. 13, the electronic component such as the light emitting element and the chip are mounted on the circuit board 23, and the lens 42 is arranged on the light emitting element. Then, one end of the light guide component 43 is fixed to the lens 42 by glue dispensing or mechanical riveting, and the other end extends out of the optical module and is in communication with other external devices in the communication system to achieve information transmission and data interaction.

It should be noted that the assembly method of the light emitting element, the lens 42 and the light guide component 43 in this step is within the understanding of those skilled in the art, and will not be described again here.

S102: assembling the isolation cover on the side of the lens facing away from the light-emitting element.

In this embodiment, as shown in FIG. 13, the isolation cover 51 is assembled on the side of the lens 42 facing away from the light emitting element. The function of the isolation cover 51 is to prevent the potting material from penetrating into the light beam propagation path during the subsequent potting process to form the potting body.

S103: sealing the assembly gaps between the circuit board, the lens, the light guide component and the isolation cover.

In this embodiment, as shown in FIG. 13, the assembly gaps between the circuit board 23, the lens 42, the light guide component 43 and the isolation cover 51 are sealed, that is, the gaps where the uncured potting material may penetrate into the light beam propagation path are sealed. Specifically, the isolation body 52 forms a seal between the lens 42 and the circuit board 23, between the lens 42 and the isolation cover 51, between the lens 42 and the light guide component 43, between the light guide component 43 and the isolation cover 51, and between the light guide component 43 and the circuit board 23.

It should be noted that the end of the light guide component 43 close to the lens 42 is usually provided with a mounting hole 431, and the relative position between the light guide component 43 and the lens 42 is fixed through the mounting hole 431. Considering that the sealing performance of the mounting hole 431 is limited, in this embodiment, it is preferred that the isolation body 52 is also provided in the mounting hole 431 to form a seal.

S104: assembling the lower housing.

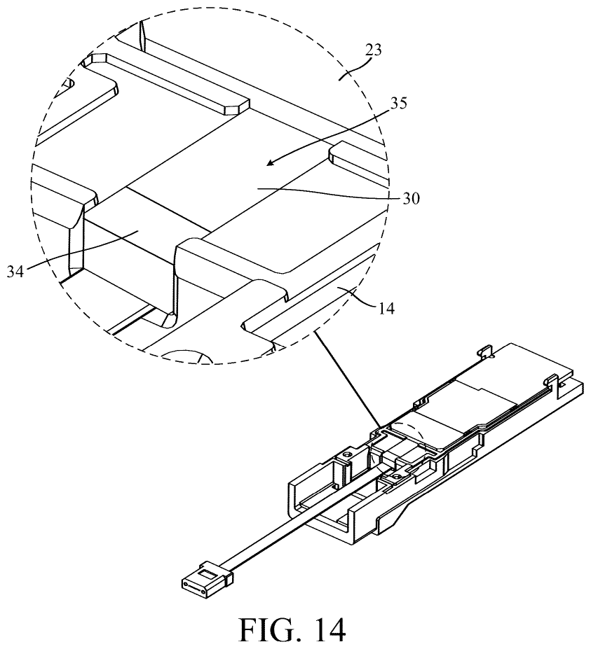

In this embodiment, as shown in FIG. 14, the side of the circuit board 23 provided with the lens 42, the light guide component 43 and the isolation cover 51 is assembled with the lower housing 14, and then flipped 180°, so that the side of the circuit board 23 away from the lens 42, the light guide component 43 and the isolation cover 51 faces upward.

S105: arranging the first limiting body and the second limiting body, and pouring the potting material to form the potting body.

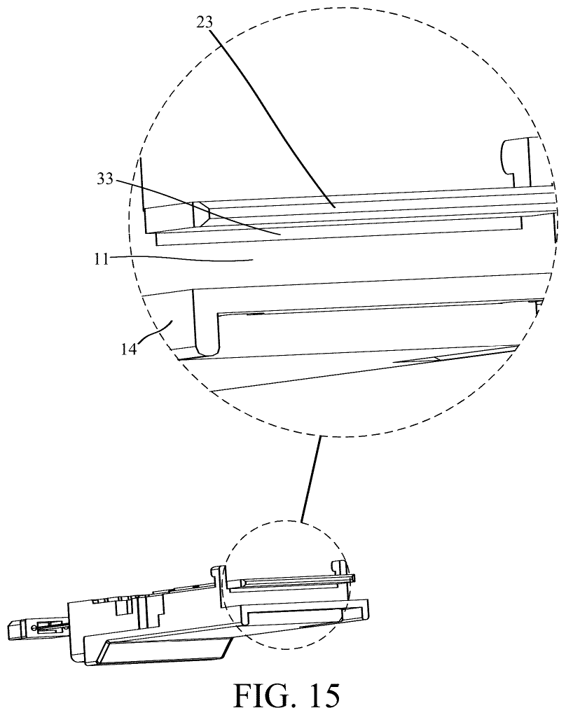

In this embodiment, as shown in FIGS. 14 and 15, the first limiting body 33 and the second limiting body 34 are provided. Specifically, the first limiting body 33 is provided between the circuit board 23 and the first retaining wall 11 of the lower housing 14, and the second limiting body 34 is provided on the lower housing 14. The first limiting body 33, the second limiting body 34, the circuit board 23 and the lower housing 14 are cooperated to form the potting cavity. The second limiting body 34 and the circuit board 23 are spaced apart from each other, so that the potting opening 35 is formed between the second limiting body 34 and the circuit board 23.

The uncured potting material is poured into the potting cavity through the potting port 35 and then solidifies to form the potting body 30. During the pouring process of the potting material, the potting material needs to cover the lower edge of the circuit board 23 (that is, the edge toward the first side), but not exceed the upper edge of the circuit board 23, so that the potting material is filled with potting material. The potting body 30 formed by solidification can form an extremely reliable seal for the sealing cavity.

S106: assembling the upper housing to complete the assembly process of the optical module.

In this embodiment, after the potting material is solidified to form the potting body 30, the upper housing 13 is assembled to complete the assembly process of the optical module. The assembled optical module is shown in FIG. 1.

The optical module provided by the present disclosure has been introduced in detail above. Specific examples are used in the present specification to illustrate the principles and implementation methods of the present disclosure. The description of the above embodiments is only used to help understand the method and the core idea of the present disclosure; in addition, for those of ordinary skill in the art, there will be changes in the specific implementation and application scope based on the ideas of the present disclosure. In summary, the content of the present specification should not be understood as a limitation of the present disclosure.

1. An optical module, characterized by including:
a housing assembly;
a circuit assembly arranged inside the housing assembly; wherein the circuit assembly has a first side and a second side that are arranged opposite each other;
a potting body arranged on the circuit assembly and cooperating with the circuit assembly to create a sealed cavity located on the first side;
a light emitting/receiving element, a lens and a light guide component, wherein a light beam propagation path cooperatively formed by the light-emitting/receiving element, the lens and the light guide component is located in the sealed cavity;
wherein the second side is in communication with an outside of the housing assembly, such that a cooling medium that has entered the housing assembly comes into contact with the circuit assembly to dissipate heat.

2. The optical module according to claim 1, characterized in that:
a potting cavity and a first heat dissipation cavity are formed between the circuit assembly and the housing assembly;
the potting cavity is located on the first side, and the potting body is potted in the potting cavity;
the first heat dissipation cavity is located on the second side, and the first heat dissipation cavity is in communication with an outside of the housing assembly, such that the cooling medium entering the housing assembly comes into contact with a surface of the circuit assembly facing toward the first cooling cavity.

3. The optical module according to claim 2, characterized in that:
a second heat dissipation cavity is formed between the circuit assembly and the housing assembly;
the second heat dissipation cavity is located on the first side, and the second heat dissipation cavity and the potting cavity are spaced apart from each other;
wherein, the second heat dissipation cavity is in communication with an outside of the housing assembly, such that the cooling medium entering the housing assembly comes into contact with the surface of the circuit assembly facing the second heat dissipation cavity.

4. The optical module according to claim 3, characterized in that:
the housing assembly is provided with a first retaining wall and a second retaining wall on the first side;
the second heat dissipation cavity is defined by the housing assembly, the circuit assembly, the first retaining wall and the second retaining wall, and the potting cavity is located on one side of the first retaining wall facing away from the second retaining wall.

5. The optical module according to claim 1, characterized in that:
the light guide component includes an optical fiber and an optical fiber fixing member located at an end of the optical fiber;
wherein, the light emitting/receiving element, the lens and the optical fiber fixing member are all located in the sealed cavity.

6. The optical module according to claim 1, characterized in that:
the circuit assembly includes a circuit board and an electronic device;
the electronic device is disposed on a surface of the circuit board facing the first side and/or the second side, the electronic device is not covered by the potting body, and the electronic device directly contacts the cooling medium to dissipate heat; and/or
the electronic device is disposed on a surface of the circuit board facing the first side, the electronic device is covered by the potting body, the circuit board is further provided with a thermal conductive structure extending from the first side to the second side, the electronic device is in communication with the thermal conductive structure on the first side, and heat generated by the electronic device is conducted to the second side through the thermal conductive structure for heat dissipation.

7. The optical module according to claim 1, characterized in that:
the optical module further includes a first limiting body and a second limiting body, and the first limiting body, the second limiting body, the circuit assembly and the housing assembly cooperate to form the potting cavity;
the first limiting body is sandwiched between the circuit assembly and the housing assembly and forms a seal;
the second limiting body is provided on the housing assembly and is spaced apart from the circuit assembly, a potting opening is formed between the second limiting body and the circuit assembly, and the potting body is potted in the potting cavity through the potting opening, wherein the potting body at a position of the potting opening is submerged beyond an edge of the circuit assembly facing the first side.

8. The optical module according to claim 1, characterized in that:
the optical module further includes:
a potting mold provided on the circuit assembly and cooperating with the circuit assembly to form a potting cavity, wherein the potting body is potted in the potting cavity.

9. The optical module according to claim 1, characterized in that:
the optical module further includes an isolation component;
the isolation component is disposed in the sealed cavity, and the light beam propagation path is isolated from the potting body through the isolation component.

10. The optical module according to claim 9, characterized in that:
the circuit assembly includes a circuit board, and the light emitting/receiving element is provided on the circuit board;
the isolation component includes an isolation cover and an isolation body;
the lens covers the light emitting/receiving element, and the isolation cover is provided on a side of the lens facing away from the light emitting/receiving element;
wherein, the isolation body forms a seal between the lens and the circuit board, between the lens and the isolation cover, between the lens and the light guide component, between the light guide component and the isolation cover, and between the light guide component and the circuit board.

11. The optical module according to claim 9, characterized in that:
the circuit assembly includes a circuit board, and the light emitting/receiving element is provided on the circuit board;
the isolation component includes a total reflection element and an isolation body;
the lens covers the light emitting/receiving element, a surface of the lens facing away from the light emitting/receiving element has a reflection area, and the light beam is totally reflected in the reflection area;
wherein, the total reflection element is attached to the reflection area, and the isolation body forms a seal between the lens and the circuit board, between the lens and the light guide component, and between the light guide component and the circuit board.
